(19) United States
(12) Patent Application Publication
(10) Pub. No.: US 2002/0030686 A1
(43) Pub. Date: Mar. 14, 2002

(54) Image display device and data writing method in image display device

(76) Inventors: Kenichiro Sakai, Kawasaki (JP); Tsugio Noda, Kawasaki (JP)

Correspondence Address: STAAS & HALSEY LLP, 700 11TH STREET, NW, SUITE 500, WASHINGTON, DC, 20001, US

(21) Appl. No.: 09/819,703

(22) Filed: Mar. 29, 2001

(30) Foreign Application Priority Data
Sep. 12, 2000 (JP) 2000-276021

(51) Int. Cl. G06T 1/60; G09G 5/39

(52) U.S. Cl. 345/531; 345/530

(57) ABSTRACT

The image display device of the present invention records information, such as the display page number, display size, display position, etc., of a display image in a non-volatile storage unit when power is switched off. If there is no user's display operation during a specific time period while the device is operated, display information is stored. When power is switched on or when a page is switched, the display information is read from the non-volatile storage unit and the image is displayed on a display unit based on the display information. In this way, user friendliness can be improved and the efficiency of user operability can be improved. The number of times of writing in the non-volatile storage unit can also be reduced.

### BACKGROUND OF THE INVENTION

1. Field of the Invention

The present invention relates to an image display device for displaying images stored in a device on a monitor and more specifically it relates to an image display device in which the page selection of a display image and the modification of both a display size and a display position can be made by user's display operations.

2. Description of Related Art

Lately, small and light portable information equipment has been widely used, and even a portable image display device provided with a small liquid crystal display (LCD) having a function to display not only text but also images has appeared.

The portable image display device comprises a storage unit for storing a variety of data, including programs and images. This storage unit is designed to store data and to prevent contents from being cancelled even if this memory unit is switched off, by using a non-volatile memory device, such as a flash memory, etc., or backing up a volatile memory, such as a DRAM, etc., by a battery. In the later case, generally a sub-battery for memory backup is provided separately from a battery for power supply.

A user stores necessary image data in portable information equipment and when referring to an image, the user switches the power supply of the equipment on. Then, after selecting one image from the plurality of images stored in the equipment by the operation button or touch panel (stylus) of the main body, the user displays his/her desired part by performing a display operation, such as enlargement/reduction, scrolling, etc., while viewing an LCD.

FIG. 1 shows display examples of image data displayed by a portable image display device.

FIG. 1 shows map images. Image data 1 are stored in the image display device as an original image. If the user selects the image data 1 after switching the power supply of the device, first, the image 2 at the initial display position is displayed on a display screen. The user performs operations, such as scrolling, etc., using operation buttons while viewing the display screen and displays image 3 in his/her desired display position on the display screen.

If in a conventional image display device, including portable information equipment with the image display function described above, power is switched off, both a selected display image and display information about the display image, such as a display size, a display position, etc., are lost. Therefore, if the user wants to display his/her desired part again when power is switched on next time, the desired image cannot be immediately displayed and the user must perform operations, such as display switching, enlargement, reduction, screen scrolling, etc., again, which is a problem (In the following description, an image stored in a device and the selection of an image are expressed as a page and page selection, respectively).

For example, if the user switches the equipment on and wants to display image 3 in the desired display position of the image data 1 again after switching the equipment off with image 3 in the desired display position displayed on the screen, image 3 in the desired display position is cancelled when power is switched off. Therefore, after switching the equipment on, the user must display image 3 by selecting the page of image data 1, displaying image 2 set in the initial display position and operating the operation buttons, etc., again.

The display state can be stored if power is not switched off. However, since it means to keep the equipment operating and the battery is consumed in a short time, it is not practical from the viewpoints of both economy and operating time.

For example, if the user wants to repeatedly refer to the same image of image data in the same state when storing map data in an image display device and displays/refers to the map image of a visiting place, the user must repeat the operation every time the user switches the equipment on even after the user displays his/her desired image. Therefore, it cannot be said to be user-friendly.

Since in the case of a portable image display device, a small display must be used, an entire image cannot be displayed on one screen. Therefore, screens must be scrolled or the display magnification of a display image must be modified. Since the user must repeat these operations every time the user switches the equipment on, operation is very troublesome.

### SUMMARY OF THE INVENTION

The present invention has been made in view of the fact described above, and it is an object of the present invention to provide an image display device in which both the power consumption of the device and the life of a memory device are taken into consideration and user-friendliness is improved.

In order to solve the problems described above, the image display device of the present invention comprises a non-volatile storage unit, an operation detection unit and a display information writing unit assuming that an image is stored in advance and the image is displayed by a user's display operation.

The non-volatile storage unit can store recorded data even if the main power supply is switched off, and the data can be rewritten.

The operation detection unit detects a user's display operation to modify the display state of the image.

The display information writing unit writes information for indicating the display state of a currently displayed image in the non-volatile storage unit based on the detection result of the operation detection unit.

The image display device of the present invention can also further comprise a display information reading unit for reading the display information described above from the non-volatile storage unit when power is switched on and an image display unit for displaying an image based on the display information read by the display information reading unit.

According to the present invention, since display information for indicating the display state of an image is stored in the non-volatile storage unit, the display state of the image can be stored even if the main power supply is switched off.

Since if power is switched on, the display information reading unit reads display information stored in the non-volatile storage unit and displays an image based on this display information, the display state of an image at the time of power switch-off can be reproduced when power is switched on again.

### BRIEF DESCRIPTIONS OF THE DRAWINGS

FIG. 1 shows examples of image data displayed by an image display device.

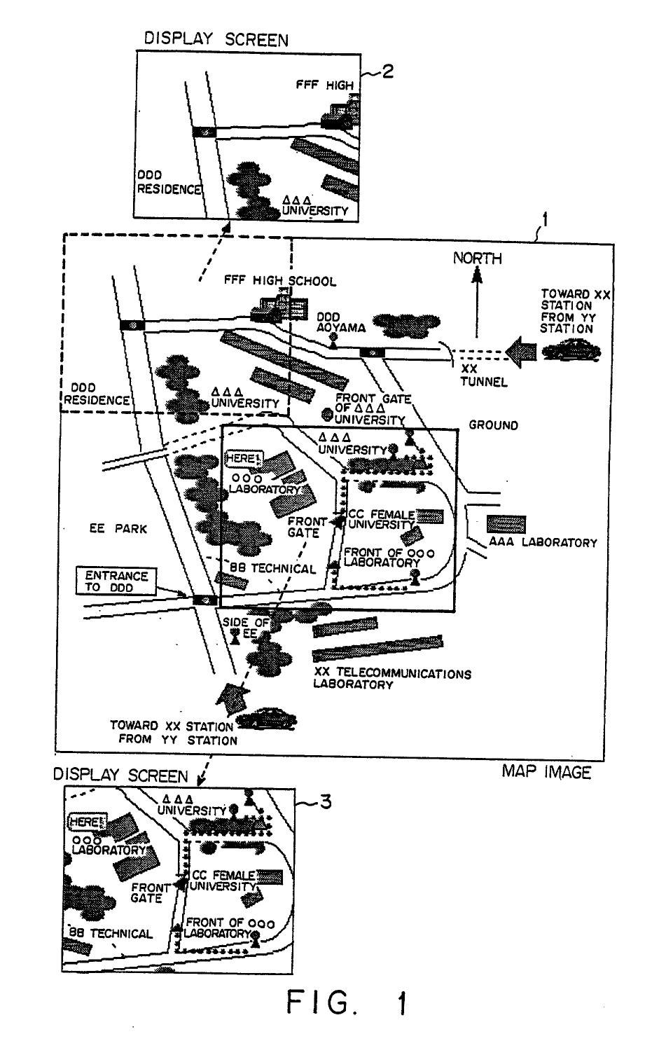

FIG. 2 shows the basic configuration of the image display device of the present embodiment.

FIG. 3 shows the hardware configuration of the image display device of the present embodiment.

FIG. 4 shows one data structure of data stored in the non-volatile storage unit when one page of display information is stored.

FIG. 5 shows one data structure of data stored in the non-volatile storage unit when all pages of display information are stored.

FIG. 6 is a flowchart showing a process in the first preferred embodiment of the display information writing unit at the time of writing display information.

FIG. 7 is a flowchart showing the process in the second preferred embodiment of the display information writing unit at the time of writing display information.

FIG. 8 is a flowchart showing a process ranging from the writing of display information till the display of an image.

FIG. 9 is a flowchart showing the process of the display information writing unit at the time of power switch-off.

FIG. 10 is a flowchart showing a process performed in the case where a function not to write if the same content is already stored when display information is written, is added.

### DESCRIPTIONS OF PREFERRED EMBODIMENTS

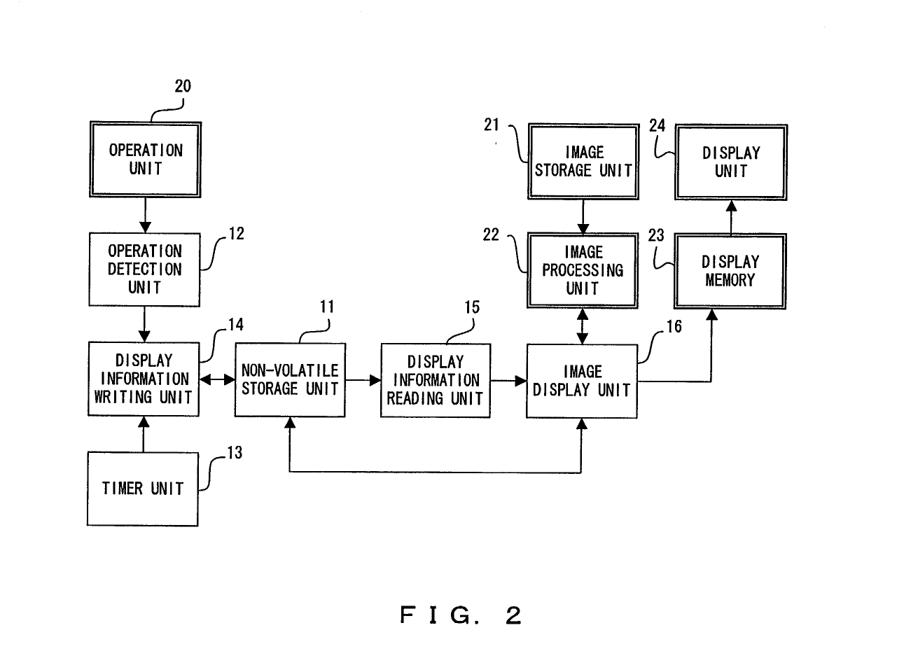

FIG. 2 shows the basic configuration of the image display device of the present embodiment.

The image display device comprises a non-volatile storage unit 11, an operation detection unit 12, a timer unit 13, a display information writing unit 14, a display information reading unit 15, an image display unit 16, an operation unit 20, an image storage unit 21, an image processing unit 22, a display memory 23 and a display unit 24.

The non-volatile storage unit 11 is a memory for storing recorded data when the main power supply is switched off, such as a flash memory, a DRAM backed up by a battery, etc., and it stores display image data. The operation detection unit 12 is used to detect a user's operation in the operation unit 20, and if a user operates the operation unit 20, such as an operation button, a touch panel, etc., it notifies the display writing unit 14 of the operation. The timer unit 13 is used to notify the display writing unit 14 of the lapse of a specific time and generates timer signals at prescribed intervals. The display information writing unit 14 is used to write display information in the non-volatile storage unit 11 and if it determines from a timer signal from the timer unit 13 and a notification from the operation detection unit 12 that there is no operation in the operation unit 20 during a specific time period, it writes display information in the non-volatile storage unit 11. The display information reading unit 15 reads the display information from the non-volatile storage unit 11 and notifies the image display unit of the display information. The screen display unit 16 displays a screen based on the display information. The operation unit 20 receives user's operations, such as page switching, enlargement/reduction, scrolling, etc., and notifies the operation detection unit 12 of the operation content. The image storage unit 21 is a non-volatile memory, such as a mask ROM, a flash memory, etc., and it stores plural pages of original image data. These original images are managed by page numbers, and the image processing unit 22 designates an image to be read by the page number. The image processing unit 22 enlarges/reduces an image read from the image storage unit 11. If image data are compressed and stored in the image storage unit 21, this image processing unit 22 restores the compressed data. The display memory 23 is a memory for storing image data to be displayed on the display unit 24. The stored data are scanned in a specific cycle, are converted into display signals and are transmitted to the display unit 24. The display unit 24 is a display device, such as an LCD, etc., and it displays an image based on display data in the display memory 23.

Next, the operation of the image display device is described.

In this preferred embodiment, when the power switch is turned off, the page number of an original display image, and the magnification and display position are temporarily stored in the non-volatile storage unit 11 as display information, and when the power switch is turned on again, the display screen is reproduced using this display information. As described later, this preferred embodiment can also be configured so that the latest display state of a referenced page is recorded when a display page is switched in addition to when the power switch is turned off.

If the power switch is turned on, the display information reading unit 15 reads display information from the non-volatile storage unit 11 and notifies the image display unit 16 of this information.

If a “display image” is stored in the non-volatile storage unit 11 as display information, the image display unit 16 writes the data of this “display image” in the display memory 23. If there is no “display image” in the non-volatile storage unit 11, the image display unit 16 instructs the image processing unit 22 to generate the data of an display image based on the “display page number”, “display position” and “display size” of the display information stored in the non-volatile storage unit 11. Then, the image processing unit 22 reads image data corresponding to a page number designated by the image storage unit 21, enlarges/reduces the image based on the “display size” and outputs the image to the image display unit 16. Then, the image display unit 16 writes the image data in the display memory 23 in such a way that an image in a position designated by this “display position” can be displayed, by referring to the “display position” included in the display information. The data stored for display in the display memory 23 are scanned in a specific cycle, are converted into display signals and are displayed on the display unit 24. It can also be configured that the process of image data by the image processing unit 22 is performed only for a part corresponding to the “display position” of image data by read by the image storage unit 21 and the data are outputted to the image display unit 16.

First, a user selects an image by performing image page switching, makes the image easy to view by enlarging/reducing the image and displays his/her desired part by scrolling a screen as a basic operation leading to displaying the desired part of a specific image. It is considered that when obtaining the desired display state after repeating these display operations several times, the user views the displayed image for a while without any operation.

In this preferred embodiment, attention is paid to this point, and when there is no subsequent display operation during a specific time period after a display operation to modify a display state in addition to when the power switch is turned off, display information is written in the non-volatile storage unit 11. In this way, since display information is stored in the non-volatile storage unit 11, when there is no user's operation during a specific time period in addition to when the power switch is turned off, the latest display state can be stored even in an unforeseen accident, such as when the battery is completely consumed, when the power supply is accidentally disconnected, etc., and it can be reproduced when power is switched on again.

Compared with the case where writing is done every time there is a user's operation, in this case, the number of times of writing in the non-volatile storage unit 11 is reduced. Since a non-volatile storage device, such as a flash memory, etc., composing the non-volatile storage unit 11 consumes much power when data are written, by reducing the number of times of writing, the operating time of both power supply battery and other batteries can be improved. And, since the physical life of the non-volatile storage device depends on the number of times of writing, by reducing the number of times of writing, the life of the non-volatile storage unit 11 can also be improved.

If a user operates the operation unit 20, such as an operation button, a switch, a touch panel, etc., the information is reported to the operation detection unit 12. The operation detection unit 12 judges whether the content of the user's operation is the modification of the display content on the display unit 24. If the content is the modification, the operation detection unit 12 notifies the display information writing unit 14 of the detection signal.

If power switch-off by a user is detected, the display information writing unit 14 stores in the non-volatile storage unit 11 display information about an image displayed on the display unit 24 when the power switch is turned off.

The timer unit 13 generates a timer signal at specific intervals and outputs the signal to the display information writing unit 14. The display information writing unit 14 writes display information in the non-volatile storage unit 11 based on both this timer signal and the detection signal from the operation detection unit 12. The display information writing unit 14 stores in advance the existence/non-existence of a detection signal from the operation detection unit 12 and judges whether the display information about a display image currently displayed on the display unit 24 should be stored, based on whether there is a detection signal prior to the notification by a timer signal. If the information writing unit 14 judges that the display information should be stored, the display information writing unit 14 stores both the display image and information indicating the display state in the non-volatile storage unit 11 as the display information.

In this way, display information is stored in the non-volatile storage unit 11 and the latest display state is reproduced when power is switched on again. When there is no user's operation during a specific time period in addition to when the power switch is turned off, display information is stored. Even in an unforeseen accident, such as when the life of the power supply is completely consumed, when the power supply is accidentally disconnected, the latest display state can be reproduced.

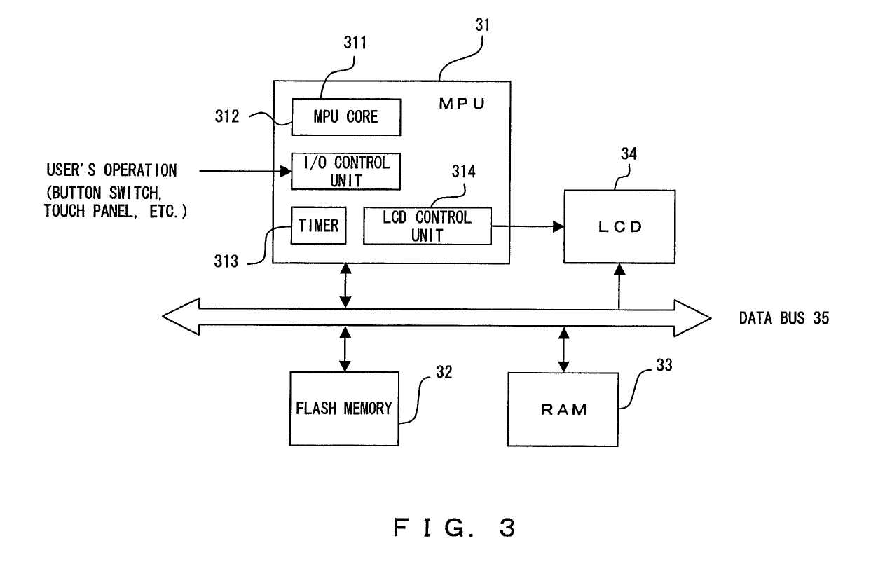

FIG. 3 shows one hardware configuration to implement the configuration of the image display device shown in FIG. 2.

The image display device shown in FIG. 3 comprises an MPU31, a flash memory 32, a RAM 33 and an LCD 34, and these units are connected to one another by a data bus 35. The MPU 31 includes an MPU core 311 for taking charge of operation/control, an I/O control unit 312 for controlling switches, etc., a timer 313 and an LCD control unit 314 for controlling an LCD. The MPU 31 sometimes includes other circuits, such as an operation circuit, etc.

Each block shown in FIG. 2 can be related to one or more hardware elements shown in FIG. 3. Specifically, both the non-volatile storage unit 11 and image storage unit 21 correspond to the flash memory 33, the operation detection unit 12 corresponds to the I/O control unit 312, and the timer unit 13 corresponds to the timer 313. The display information writing unit 14, display information reading unit 15, image display unit 16 and image processing unit 22 correspond to the MPU core 311, the display memory 33 corresponds to the RAM 33, and the display unit 24 corresponds to both the LCD control unit 314 and LCD display 34.

Since each hardware element shown in FIG. 3 is also included in a general portable information equipment, this preferred embodiment can be easily applied to a general portable information equipment.

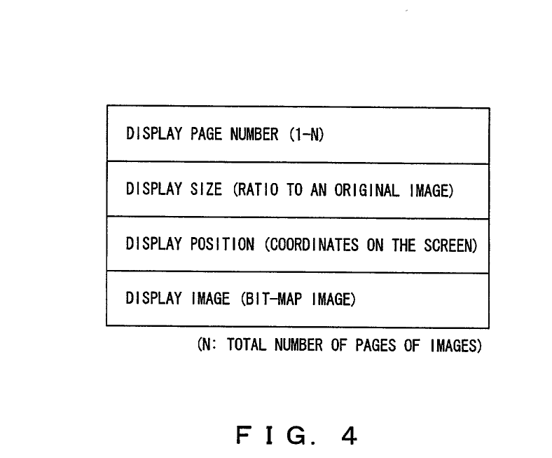

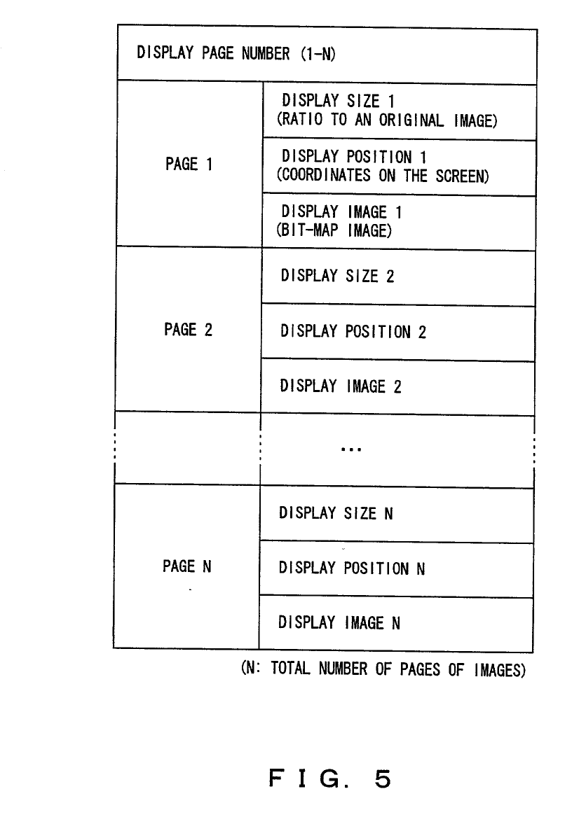

FIGS. 4 and 5 shows data structures of data stored in the non-volatile storage unit 11. FIG. 4 shows one data structure in the case where display information only about the latest display state of the last page is stored. FIG. 5 shows one data structure in the case where a plurality of pieces of display information for indicating the respective latest display states of all pages are stored.

In the case of the structure shown in FIG. 4, display information comprises a “display page number” for indicating a target original image by the page number, a “display size” for indicating the size of a display image by a ratio of the display image to the original image, a “display position” for indicating the position in the original image of a target part by the coordinates of the top left of the original image using the top left of the display screen of the display unit 24 as the origin and a “display image” for storing a display image as bit-map image data. Image data are not always stored in the “display image”. Sometimes image data are not stored, for example, in the initial state of the device immediately after shipment, or due to the capacity problem of the non-volatile storage unit 11, etc. In such a case, identification data for indicating that no image data are stored, is stored in this “display image” section so that the display information reading unit 15 can judge whether there are image data. It can also be configured so that data are compressed and stored in this “display image”. In this case, the display information writing unit 14 compresses data when the data is stored the data in the non-volatile storage unit 11, and the display information reading unit 15 restores the data when the data is read.

Since by using the data in this “display image”, data can be stored for display in the display memory 23 faster by a time spent for the process, such as the enlargement/reduction of an image, etc., in the image processing unit 22, a time spent between the switch-on of the power supply till the display of an image can be reduced. In particular, in the case of a portable device, since the process function is restricted by small size/small power consumption, this difference is very important.

In the case of the data structure shown in FIG. 4, the “display page number” becomes the page number of a display image displayed on the display screen when power is switched on again. When power is switched on, an original image corresponding to this page number is read from the image storage unit 21, and display data obtained by processing the image are stored for display in the display memory 23. In this way, when power is switched on again, the part of an image in the same position of the same page can be displayed in the same size when power is switched off.

In the case of the data structure shown in FIG. 5, display information (excluding a “display page number”) about the latest display state of the page of each image data stored in the image storage unit 21 of the image display device is stored. In the case of the structure shown in FIG. 5, the “display size”, “display position” and “display image” of each of the original images with page numbers 1 to N is stored. In the case of the structure shown in FIG. 5, when a user switches a display page, display information about an original image with a corresponding page number is read from the non-volatile storage unit 11. If image data are recorded in the “display image” as display information, the image data are stored for display in the display memory 23 and the display screen of the image data is displayed on the display unit 23. If no image data are recorded, image data generated by the image processing unit 22 based on both the “display size” and “display position”, are stored for display in the display memory 23 and the display screen is displayed on the display unit 24.

In the case of the data structure shown in FIG. 5, since display information is stored for each page, the efficiency of user's operations can be improved by reducing the number of operations required when a user refers to a plurality of images.

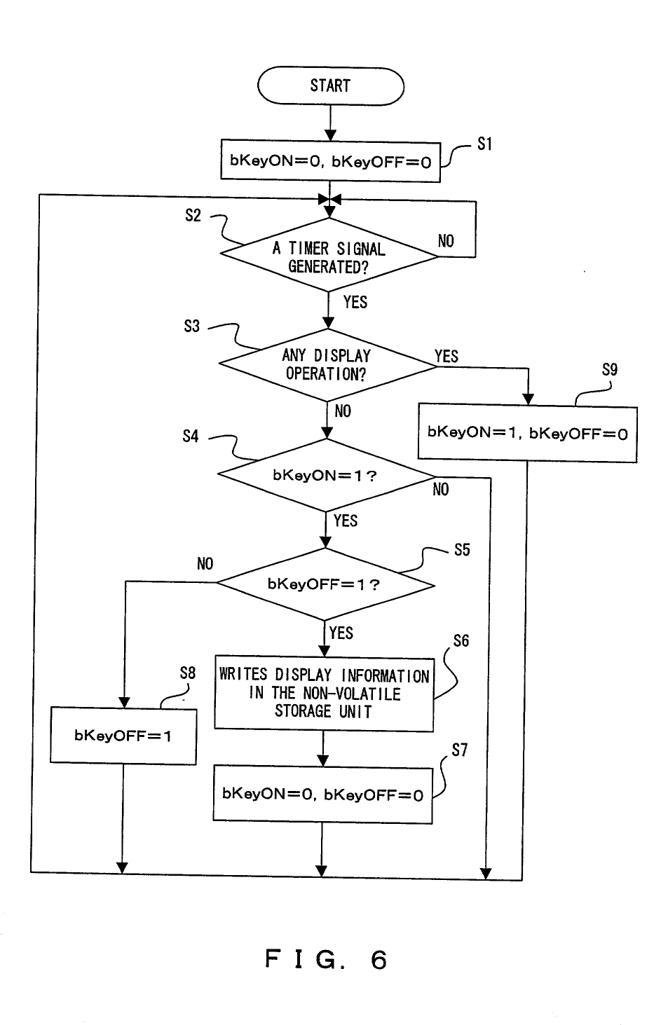

FIG. 6 is a flowchart showing the first preferred embodiment of the display information writing unit 14 performed at the time of writing display information.

In the process flow shown in FIG. 6, two variables bKeyON and bKeyOFF are used to indicate the input states of a user's operation. Variable bKeyON is used to indicate whether there is a key input, and variable bKeyOFF is used to indicate whether there is no key input during a specific time period.

When power is switched on, first, in step S1, the display information writing unit 14 initializes variables bKeyON and bKeyOFF to 0.

Then, in step S2, the information writing unit 14 checks whether the timer unit 13 generates a timer signal. If no timer signal is generated, the process returns to step S2 and the information writing unit 14 continues to wait for a timer signal. If a timer signal is generated, the process proceeds to step S3.

Instep S3, the information writing unit 14 checks whether there is a user's display operation to modify a display screen. If there is a display operation (Yes in step S3), display information is not written in the non-volatile storage unit 11. Therefore, after setting the variables bKeyON=1 and bKeyOFF=0 in step S9, the process returns to step S2 and the information writing unit 14 waits for a subsequent timer signal.

If in step S3 the user's display operation is not detected (No in step S3), in step S4 the information writing unit 14 checks whether bKeyON is 1, that is, whether a user's display operation is detected in the previous step S3 where a timer signal is generated. As a result, if bKeyON=0 (No in step S4), the image information of a display image currently displayed and the display information in the non-volatile storage unit 11 are the same, and there is no need to update the stored data. Therefore, the process returns to step S2 and the information writing unit 14 waits for a subsequent timer signal.

If in step S4 bKeyON=1 (Yes in step S4), in step S5 the information writing unit 14 checks whether bKeyOFF=1, that is, whether there is no modification of the display image during a specific time period. As a result, if bKeyOFF=0, that is, if there is not a specific time period after the last display operation (No in step S5),it means that there was no user's display operation between the previous timer signal and the current timer signal. Therefore, after in step S8 bKeyOFF is set to 1, the process returns to step S2 and the information writing unit 14 waits for a subsequent timer signal. If bKeyOFF=1, that is, if a specific time elapses after the last display operation (Yes in step S5), in step S6 the information writing unit 14 writes as display information the “display page number”, which is the page number of a currently displayed image, “display size” for indicating the enlargement/reduction magnification of an original image and “display position” for indicating the displayed part of an original image in the non-volatile storage unit 11. At this moment, if the no-volatile storage unit 11 has room in the capacity, the “display image” can also be stored in the non-volatile storage unit 11.

If the writing of display information is completed, in step S7 the information writing unit 14 sets both variables bKeyON and bKeyOFF to 0 and the process returns to a timer signal waiting condition in step S2.

If the display information writing unit 14 repeats the processes in and after step S2, display information is written in the non-volatile storage unit 11 only when there is no subsequent user's display operation during a specific time period after the last user's display operation, that is, between two timer signals.

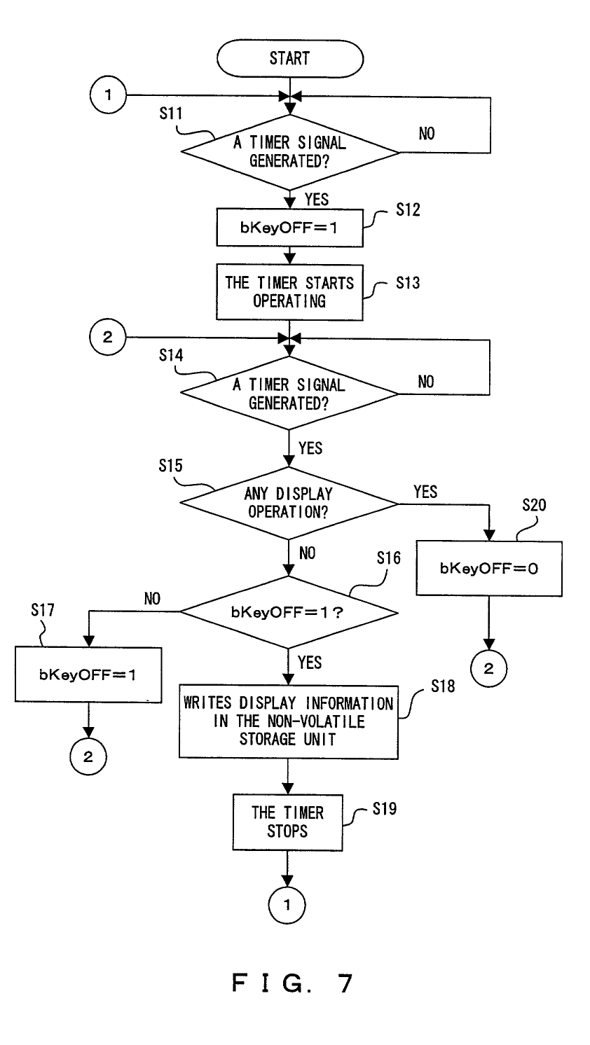

FIG. 7 is a flowchart showing the process of the second preferred embodiment of the display information writing unit 14 at the time of writing display information. This process flow differs from the process flow shown in FIG. 6 in that the timer unit 13 is activated only when there is a user's display operation. In the process flow shown in FIG. 7, variable bKeyOFF is used to indicate the input state of a user's operation.

In the process flow shown in FIG. 7, if power is switched on, first, in step S11, the display information writing unit 14 checks whether a user performs a display operation to modify a display image on the display unit 24. If such a display operation is not performed (No in step S11), the process returns to step S11 and the information writing unit 14 continues to wait for such a display operation. If the user performs such a display operation (Yes in step S11), the process proceeds to step S12, and after setting bKeyOFF=1, in step S13 the information writing unit 14 instructing the timer unit 13 to activate a timer and to generate a timer signal at specific intervals.

Then, in step S14, the information writing unit 14 checks whether the timer unit 13 generates a timer signal. If no timer signal is generated (No in step S14), the process returns to step S14 and the information writing unit 14 continues to wait for a timer signal. If a timer signal is generated (Yes in step S14), the process proceeds to step S15.

In step S15, the information writing unit 14 checks whether there is a user's display operation as in step S11. If there is a display operation (Yes in step S15), after in step S20 bKeyOFF=0 is set, the process returns to step S14 and the information writing unit 14 waits for a subsequent timer. If in step S15 there is no display operation (No in step S15), the process proceeds to step S16.

In step S16, the information writing unit 14 checks whether bKeyOFF is 1, that is, whether there is another display operation between the immediately previous display operation and the generation of a timer signal. If bKeyOFF is 0 (No in step S16), it is judged that there is a subsequent display operation, and after bKeyOFF=1 is set as in step s17, the process returns to step S14. If in step S16 bKeyOFF is 1 (Yes in step S16), it is judged that there was no subsequent display operation and the process proceeds to step S18.

In step S18, the “display page number”, “display size” and “display position” of a currently displayed image are stored in the non-volatile storage unit 11 as display information and the process proceeds to step S19. In this case, if the non-volatile storage unit 11 has room in the capacity, the “display image” can also be stored in the non-volatile storage unit 11.

After in step S19 the timer unit 13 is stopped, the process returns to step S11 again and the processes in and after step S11 are repeated.

Since in the process flow shown in FIG. 7, a timer is not activated until there is a user's display operation, process load can be reduced compared with the case where a timer is always activated as in the process flow shown in FIG. 6.

Next, a process ranging from the reading of display information till the display of an image is described.

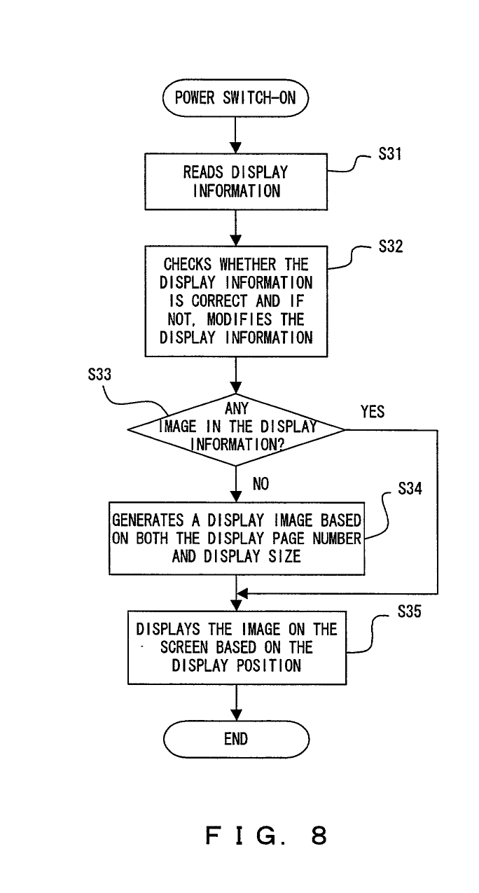

FIG. 8 is a flowchart showing the processes of both the display information reading unit 15 and image display unit 16.

First, if power is switched on or a user switches a display page, in step S31 the display information reading unit 15 reads display information about a corresponding page from the non-volatile storage unit 11 and notifies the image display unit 16 of the information.

Then, in step S32, the image display unit 16 checks whether the display information read from the non-volatile storage unit 11 by the display information reading unit 15 is correct. If the display information is irregular, the irregularing is corrected by replacing the display information with a predetermined value. For example, if a “display page number” is larger than the total page number of original images stored in the device, the “display page number” is corrected to the page number of the last page or top page. If a “display size” for indicating the magnification of a display image exceeds a prescribed range, the value of the “display size” is corrected to the upper or lower limit value of the prescribed range. If the value of a “display position” is out of the display range of the display unit 24, the “display position” is corrected to be within the display range of the display unit 24.

If data are stored in the “display image” of display information (Yes in step S33) after such a matching check/correction of the display information, the process proceeds to step s35 to use the data. If no data are stored (No in step S33), in step S34 original image data corresponding to the “display page number” in the display information are read from the image storage unit 21. Then, the image processing unit 22 generates image data by enlarging/reducing the original image data by magnification indicated by the “display size” and the process proceeds to step S35.

In step S35, the data in the “display image” read in step S31 or image data generated in step S34 are displayed on the display unit 24 based on the “display position” in the display information and the process is terminated.

By performing this process when power is switched on or when a user switches a display page by a display operation, an image displayed before power is previously switched off or when the page is last referenced can also be directly displayed without a user's display operation. Even if mismatched display information is stored in the non-volatile storage unit 11 immediately after shipment, or if power is disconnected due to the way of writing in the non-volatile storage unit 11, etc., since the image display unit 16 checks and modifies the display information, image data obtained by using the mismatched information can be prevented from being displayed.

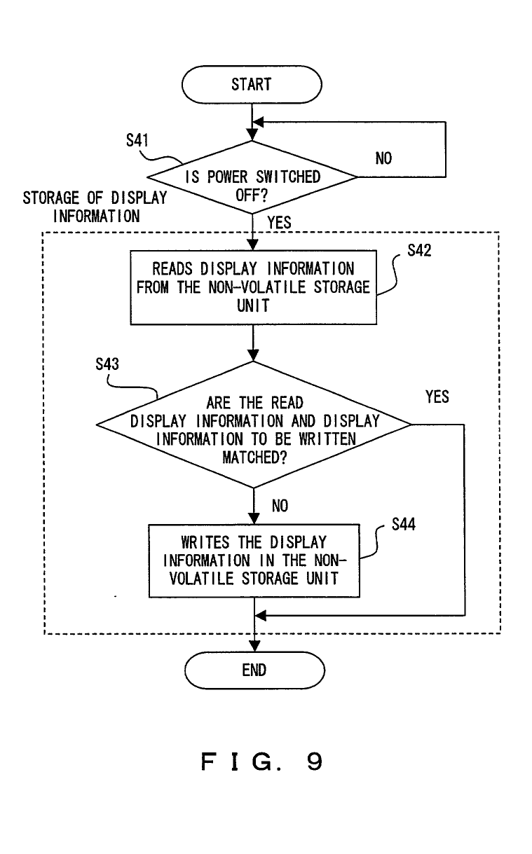

FIG. 9 is a flowchart showing the process of the display information writing unit 14 performed when a user turns the power switch off.

When detecting a user's power switch-off operation (No in step S41), in step S42 the display information writing unit 14 reads display information corresponding to a currently displayed page in the non-volatile storage unit 11.

Then, in step S43 the display information read from the non-volatile storage unit 11 is compared with the page number, magnification and display position of the currently displayed image. If they are not matched as a result of the comparison (No in step S43), in step S44 information indicating the page number, magnification and display position is written as display information corresponding to the currently displayed image data in the non-volatile storage unit 11 and the process is terminated. If in step S44 they are the same (Yes in step S43), the process is terminated without any process since there is no need to write the display information in the non-volatile storage unit 11.

Since the display information writing unit 14 performs such a process shown in FIG. 9, unnecessary writing in the non-volatile storage unit 11 can be avoided.

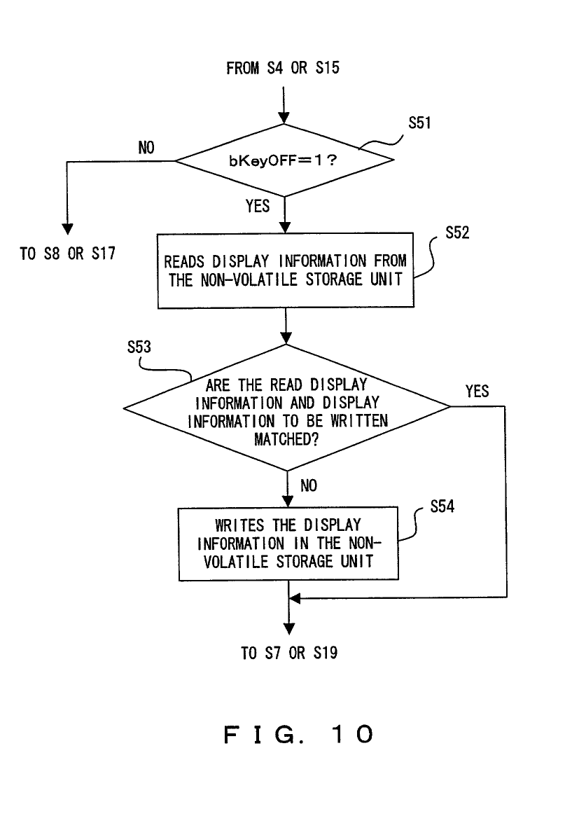

FIG. 10 is a flowchart showing the process performed in the case where a function to prevent display information from being written if display information to be written is the same as data stored in the non-volatile storage unit 11 when the display information is written in the display information writing unit 14. The flowchart shown in FIG. 10 should be replaced with steps S5 and S6 of the flowchart shown in FIG. 6 or steps S16 through S18 of the flowchart shown in FIG. 7. In this way, if the read display information and display information to be written are the same, the display information writing unit 14 can omit the writing in the non-volatile storage unit 11.

Following the step S4 shown in FIG. 6 or step S15 shown in FIG. 7, in the flowchart shown in FIG. 10, first in step S51 the value of variable bKeyOFF is checked. If as a result, bKeyOFF is 0 (No in step S51), the process proceeds to step S8 or step S15 in FIGS. 6 and 7, respectively, since it means that user display operation is detected during the specific time period after the previous display operation.

If in step S51 bKeyOFF is 1 (Yes in step S51), in step S52 display information is read from the non-volatile storage unit 11 since it means that there was no subsequent user display operation during the specific time period. Then, display information to be written in the non-volatile storage 11 and the display information read in step S52 are compared (step S53). If they are found to be different as a result of the comparison (No in step S53), in step S54 the display information is written in the non-volatile storage unit 11 and the process proceeds to step S7 or step S19 in FIGS. 6 and 7, respectively. If they are the same (Yes in step S53), the process proceeds to step S7 or step S19 in FIGS. 6 and 7, respectively, without any writing in the non-volatile storage unit 11 since there is no need to update the information in the non-volatile storage unit 11.

If the same display information is already stored in the non-volatile storage unit 11, such as if the screen consciously or accidentally returns the original display state as a result of a series of user's operations, etc., there is no need to write it again. Therefore, by adding the process shown in FIG. 10, the display information writing unit 14 can skip unnecessary writing in the non-volatile storage unit 11. In this way, the number of times of writing in the non-volatile storage unit 11 can be reduced. As a result, power consumption can be suppressed and the lives of used power supply battery and other batteries can be improved. The life of a memory device used in the non-volatile storage unit 11 can also be improved.

As described above, according to the image display device of the present invention, if power is switched off, display information for indicating the display state of an image can be stored. Therefore, if there is no user's operation instruction, the part of an image that is previously reference can be displayed in the same state when power is switched on or when a page is switched. In this way, since there is no need for a user to repeat the same operation when power is switched again or when a screen is switched, user-friendly operability can be implemented.

Since it can be configured so that display information can be written in the non-volatile memory device if a user does not perform a display operation during a specific time period, the number of times of writing can be reduced to a required minimum. Therefore, power consumption can be suppressed and the life of a power supply battery can be improved. By reducing the number of times of writing in a non-volatile memory device, the life of the non-volatile memory device can also be improved.

Furthermore, even if stored display information is irregular, the display information can be checked and corrected. Therefore, there is no display due to mismatched display information.

If display image data are stored, a time required to display can be reduced by using the data as a display image.

Furthermore, by storing display information for each page, the number of user's instructions made when a user refers to a plurality of images can be reduced and as a result, the efficiency of a user operability can be improved.

What is claimed is:

1. An image display device for storing an image and displaying the image based on a user's display operation, comprising:
a non-volatile storage unit storing data which can be rewritten and maintaining stored data even if a main power supply is switched off;
an operation detection unit detecting a user's display operation to modify a display state of the image; and
a display information writing unit writing display information for indicating a display state of a currently displayed image in the non-volatile storage unit based on a detection result of the operation detection unit.

2. The image display device according to claim 1, further comprising:
a display information reading unit reading the display information from said non-volatile storage unit when power is switched on; and
an image display unit displaying an image based on display information read by the display information reading unit.

3. The image display device according to claim 2, wherein if the display information read from said non-volatile storage unit is not a prescribed value, said display information reading unit modifies the display information to a prescribed rating value.

4. The image display device according to claim 2, wherein said display information writing unit stores currently displayed display image data in said non-volatile storage unit, said display reading unit reads the display image data as well as the display information if the display image data are stored in said non-volatile storage unit and said image display unit displays an original image using the read display image data.

5. The image display device according to claim 1, wherein if said operation detection unit does not detect another user's display operation during a specific time period after detecting a user's display operation, said display information writing unit writes the display information in said non-volatile storage unit.

6. The image display device according to claim 1, wherein if display information to be written in said non-volatile storage unit is the same as a value stored in said non-volatile storage unit, said display information writing unit does not write the display information.

7. The image display device according to claim 1, wherein said display information writing unit independently stores the display information for each stored image.

8. The image display device according to claim 7, wherein when a display image is switched, said display information reading unit reads the display information corresponding to the display image.

9. The image display device according to claim 1, wherein the display information includes at least one of information for specifying an original image, information about magnification of a display image and information for indicating a position in the original image of a display image.

10. The image display device according to claim 1, wherein if a user switches a main power supply off, said display information writing unit writes the display information in said non-volatile storage unit.

11. An image display device for storing an image and displaying the image based on a user's display operation, comprising:
a non-volatile storage unit storing data which can be rewritten and maintaining stored data even if a main power supply is switched off; and
a display information writing unit writing display information for indicating a display state of a currently displayed image in said non-volatile storage unit if a main power supply is switched off.

12. An image display device for storing an image and displaying the image based on a user's display operation, comprising:
non-volatile storage means for storing data which can be rewritten and maintaining stored data even if a main power supply is switched off;
operation detection means for detecting a user's display operation to modify a display state of the image; and
display information writing means for writing display information for indicating a display state of a currently displayed image in the non-volatile storage means based on a detection result of the operation detection means.

13. An image display device for storing an image and displaying the image based on a user's display operation, comprising:
non-volatile storage means for storing data which can be rewritten and maintaining stored data even if a main power supply is switched off; and
display information writing means for writing display information for indicating a display state of a currently displayed image in said non-volatile storage unit if a main power supply is switched off.

14. A method for writing a display state of an image in an image display device for storing an image and displaying the image based on a user's display operation in a non-volatile storage unit for maintaining stored data even if power is switched off, comprising:
detecting a user's display operation to modify a display state of the image; and
writing display information for indicating a display state of a currently displayed image based on a result of the detecting.
